(19) United States
(12) Patent Application Publication
(10) Pub. No.: US 2019/0319345 A1
(43) Pub. Date: Oct. 17, 2019

(54) ANTENNA ASSEMBLY FOR MOBILE DEVICES AND VEHICLES

(71) Applicant: Furrion Property Holding Limited, Hong Kong (HK)

(72) Inventors: Steven Neill Bell, Hong Kong (HK); Karl Wai Ho Fung, Hong Kong (HK)

(21) Appl. No.: 16/387,124

(22) Filed: Apr. 17, 2019

(30) Foreign Application Priority Data
Apr. 17, 2018 (HK) 18104970.6

(51) Int. Cl. H01Q 1/32; H01Q 21/24; H01Q 21/28; H01Q 9/04; H01Q 1/24; H04B 7/0413; H04B 7/08; H04B 7/10

(52) U.S. Cl. CPC H01Q 1/3275; H01Q 21/24; H01Q 21/28; H04B 7/10; H01Q 1/243; H04B 7/0413; H04B 7/0802; H01Q 9/0407

(57) ABSTRACT

An antenna assembly for a mobile device has a base, a first antenna affixed to the base, a second antenna affixed to the base, and a housing affixed to the base. The first antenna is aligned on the base along a first axis, and the second antenna is aligned on the base along a second axis. The first axis is offset at an angle from the second axis. The housing at least partially encloses the first antenna and the second antenna. In embodiments, the first antenna is the same type of antenna as the second antenna. A vehicle or a mobile phone may contain the antenna assembly as described herein.

### CROSS-REFERENCE TO RELATED APPLICATION

The present application claims the benefit of Hong Kong Application No. 18104970.6, filed Apr. 17, 2019, which is herein incorporated by reference in its entirety.

### FIELD OF THE INVENTION

Embodiments of the invention relate to antenna assemblies. More specifically, embodiments of the invention relate to antenna assemblies having multiple antennas therein, and vehicles and mobile devices containing such antenna assemblies.

### BACKGROUND

Antennas are ubiquitous in everyday life and are located in mobile devices such as phones, vehicles, car fobs, etc. Antenna assemblies and even mobile antenna assemblies having multiple antennas therein are also known for, example, to receive a variety of cellular, terrestrial, and/or satellite signals. See, for example, US 2014/0292593 A to Thiam, et al., published on Oct. 2, 2014; US 2006/0273967 A1 to Gat, et al., published on Dec. 7, 2006; US 2014/0043204 A1 to Basanayake, et al., published on Feb. 13, 2014; US 2013/0229315 A1 to Duzdar, et al., published on Sep. 5, 2013; and CN 203774449 U to Liang Huixin, published on Aug. 13, 2014.

There remains, however, a need for improved antenna assemblies for mobile devices. Such an antenna that provided enhanced reception regardless of the orientation of the antenna assembly relative to the connecting antenna would be particularly advantageous.

### SUMMARY

An embodiment of the present invention relates to an antenna assembly for a mobile device having a base, a first antenna affixed to the base, a second antenna affixed to the base, and a housing affixed to the base. The first antenna is aligned on the base along a first axis, and the second antenna is aligned on the base along a second axis. The first axis is offset at an angle from the second axis. The housing at least partially encloses the first antenna and the second antenna. Furthermore, the first antenna is the same type of antenna as the second antenna. Alternatively, the first antenna and the second antenna are identical.

Embodiments of the invention herein relate to a vehicle containing the antenna assembly as described herein. Embodiments of the invention herein relate also to mobile devices such as mobile phones and tablets containing the antenna assembly as described herein.

Without intending to be limited by theory, it is believed that the antenna assembly herein provides a convenient, small, antenna assembly which provides overall improved coverage (i.e., reception and/or transmission) of wireless frequencies while the antenna assembly is moving around, changing direction, etc. This in turn may lead to fewer dropped calls, higher data transmission rates, a more reliable connection, etc. It is also believed that embodiments of the present invention enable the cell and/or internet connection, for example in a vehicle or a mobile phone, either by improving reception with the mobile network or the public Wi-Fi network. In addition, the common mode antenna design saves volume, and the multiple antennas support both non-coexisting network demand.

In embodiments, the antenna may also act as a Wi-Fi™ booster for use in the vicinity of, for example, a vehicle. For example, when a vehicle is parked and the user has activities outside of the vehicle, but still within the vicinity of the vehicle, the user may still use the Wi-Fi™ network generated by the router attached to the antenna assembly on the inside of the vehicle. Thus, embodiments of the antenna assembly may further act as a local wireless booster, if desired. Without the antenna assembly, the Wi-Fi™ may be limited in coverage to the inside of the vehicle and the wireless signal(s) outside of the vehicle may typically be significantly weaker or even non-existent.

Disclosed embodiments include an antenna assembly for a mobile device comprising: a base; a first antenna affixed to the base, wherein the first antenna is aligned on the base along a first axis; a second antenna affixed to the base, wherein the second antenna is aligned on the base along a second axis, wherein the second axis is offset at an angle from the first axis; and a housing affixed to the base at least partially enclosing the first antenna and the second antenna, wherein the first antenna is the same type of antenna as the second antenna; or wherein the first antenna and the second antenna are identical.

In embodiments of any of the antenna assemblies described above, the angle is from about 45° to about 90°; or from about 75° to about 90°; or from about 85° to about 90°.

In embodiments of any of the antenna assemblies described above, the first antenna and the second antenna are each a directional antenna; or wherein the first antenna and the second antenna are selected from the group consisting of a microstrip antenna, a radio frequency printed circuit board antenna, a planar array antenna, or wherein the first antenna and the second antenna are both radio frequency printed circuit board antennas.

In embodiments of any of the antenna assemblies described above, the first antenna and the second antenna each have a maximum directive gain of from about 0.5 to about 15 dBi; or from about 1 to about 12 dBi; or from about 2 to about 10 dBi.

In embodiments of any of the antenna assemblies described above, the first antenna and the second antenna comprise a cellular antenna selected from the group consisting of a 3G antenna, a 4G antenna, a 5G antenna, a 6G antenna, a CDMA antenna, a Long Term Evolution (LTE) antenna, and a combination thereof.

In embodiments of any of the antenna assemblies described above, the assemblies can further comprise a long-range antenna; or a long range antenna selected from the group consisting of a broadcast television antenna, a satellite antenna, a digital radio antenna, and a combination thereof, affixed to the base.

In embodiments of any of any of the antenna assemblies described above, the assemblies can further comprise a short-range wireless antenna selected from the group consisting of a Wi-Fi™ antenna, a Bluetooth™ antenna, a Zigbee™ antenna, and a combination thereof.

In embodiments of any of any of the antenna assemblies described above, the first antenna and the second antenna are selected from the group consisting of a monopole antenna, an inverted F antenna, an inverted L antenna, a planar F antenna, a patch antenna, a multiple patch antenna, and a combination thereof.

In embodiments of any of any of the antenna assemblies described above, the first antenna is located within about 30 cm of the second antenna; or within about 20 cm of the second antenna; or within about 15 cm of the second antenna.

In embodiments of any of any of the antenna assemblies described above, the housing substantially; or completely, encloses the first antenna and the second antenna.

In embodiments of any of any of the antenna assemblies described above, the assemblies can further comprise a third antenna, wherein the third antenna is the same type of antenna as the first antenna and the second antenna; or wherein the first antenna, the second antenna, and the third antenna are identical, wherein the third antenna is affixed to the antenna assembly, wherein the third antenna is aligned along a third axis, and wherein the third axis is offset at an angle from the first axis, and wherein the third axis is offset at an angle from the second axis.

Embodiments include a vehicle comprising the antenna assembly according to any one of the previous embodiments. The vehicle can be a recreational vehicle.

Embodiments include a mobile phone comprising the antenna assembly according to any one of the previous embodiments.

### BRIEF DESCRIPTION OF THE DRAWINGS

Aspects of the present invention will now be described in further detail by way of example with reference to the accompanying drawings, in which:

FIG. 1 shows an exploded view of an embodiment of an antenna assembly of the present invention; and

FIG. 2 shows a top perspective view of an embodiment of an antenna assembly of the present invention showing the housing affixed to a long-range antenna housing.

The figures provided herein are for illustrative purposes only and are not necessarily drawn to scale.

### DETAILED DESCRIPTION

Unless otherwise specifically provided, all measurements are made in metric units. Furthermore, all percentages, ratios, etc. herein are by weight, unless specifically indicated otherwise. As used herein the term “affixed” indicates that one element is attached to another element, either directly or indirectly, and may be attached temporarily, permanently and/or removably. The various elements may be affixed via any method or device known in the art, such as, but not limited to a fastener (e.g., a screw, a hook-and-loop fastener, a snap, a bolt, etc.), an adhesive, welding, soldering, sealing (e.g., ultrasonic sealing, heat sealing, vacuum sealing, etc.), a mechanical tunneling tube to isolate the other connection cables in between, and a combination thereof.

The present invention relates to an antenna assembly for a mobile device having a base, a first antenna affixed to the base, a second antenna affixed to the base, and a housing affixed to the base. The first antenna is aligned on the base along a first axis, and the second antenna is aligned on the base along a second axis. The first axis is offset at an angle from the second axis. The housing at least partially encloses the first antenna and the second antenna. Furthermore, the first antenna is the same or similar type of antenna as the second antenna. Alternatively, the first antenna and the second antenna are identical.

An embodiment of the invention herein relates to a vehicle containing the antenna assembly as described herein. Another embodiment of the invention herein relates to a mobile phone or other mobile device such as a tablet containing the antenna assembly as described herein.

Without intending to be limited by theory, it is believed that by having the same or similar type of antenna, or identical antennas offset by an angle, typically from about 45° to about 90°, or from about 75° to about 90°; or from about 85° to about 90°, it has been found that the antenna coverage is enhanced, reducing blind spots. For example, it may be that due to the non-isotropic nature of the antenna, the first antenna's coverage extends further in the forward and back direction, while the second antenna's coverage extends further in the left and right directions. Thus, it is believed that by offsetting the antennas at an angle between the first axis and the second axis, the overall coverage will be enhanced. Furthermore, it is believed that such a feature is especially useful in a mobile antenna for a mobile device; or a vehicle, as the constantly-changing direction and orientation in the use of a mobile device can cause, for example, lost connections, reduced reception, reduced data transmission/reception, and/or dropped calls. In embodiments, the first, second and/or third antennas (i.e., in the embodiments described below with a third antenna) are configured to receive and transmit at the same frequency.

In an embodiment herein, the first antenna and the second antenna are each a directional antenna, or an omni-directional antenna having a non-perfect isotropic field/coverage. Thus, the first antenna and the second antenna typically each have a maximum directive gain of from about 0.5 to about 15 dBi; or from about 1 to about 12 dBi; or from about 2 to about 10 dBi according to standard tests. Such tests, for example, can be under a controlled environment including a reference antenna on calibrated measurement equipment, shielded and reflective effects eliminated environment. Taking the measurement data by rotating the antenna in a 360° under two polarization planes. The antenna gain in minimum, average and maximum are found. In an embodiment herein, the first antenna and the second antenna are selected from the group of a microstrip antenna, a radio frequency printed circuit board antenna, a planar array antenna, a Yagi-Uda antenna, and a combination thereof; or the first antenna and the second antenna are both radio frequency printed circuit board antennas. In an embodiment herein, the first antenna or the second antenna are selected from; or both selected from, the group of a monopole antenna, an inverted F antenna, an inverted L antenna, a planar F antenna, a patch antenna, a multiple patch antenna, and a combination thereof. Without intending to be limited by theory it is believed that these types of antennas are especially useful in the invention due to their ease of manufacture, directionality of coverage, low power requirements, compatibility and stability in mobile and vehicle platforms, etc. These antennas are also useful herein because they are durable, capable of being fine-tuned for use in vehicles, and are subject to strict material control.

In an embodiment herein, the first antenna and the second antenna include; or are cellular antennas, especially those for receiving and transmitting signals to cellular antenna towers for mobile phones, data, etc. Thus, in an embodiment herein the first antenna and the second antenna may be selected from the group of a 3G antenna, a 4G antenna, a 5G antenna, a 6G antenna, a CDMA (code-division multiple access) antenna, a Long Term Evolution (LTE) antenna, and a combination thereof.

In an embodiment herein, the antenna assembly further contains a long-range antenna affixed to the base and is for receiving and/or transmitting additional long-range signals (e.g., at a different frequency than the first, second and/or third antennas). As used herein, the term “long-range” indicates a distance of greater than about 100 meters (e.g., in embodiments, a relatively long distance with respect to the distance that the first, second and/or third antennas are configured to operate at). Thus, a long-range antenna is an antenna which is intended to receive and/or transmit signals a distance greater than 100 meters, and a long-range signal indicates a signal which is normally receivable a distance greater than 100 meters and/or is intended to be transmitted over a distance of greater than 100 meters. The long-range antenna may be, for example, a long-range antenna; or a long range antenna selected from the group consisting of a broadcast television antenna, a satellite antenna, a digital radio antenna, and a combination thereof.

An embodiment of the antenna assembly herein may further contain a short-range antenna as well. As used herein, the term “short-range” indicates a distance of less than or equal to about 100 meters (e.g., in embodiments, a relatively short distance with respect to the distance that the long-range antenna is configured to operate at). Thus, in an embodiment of the present invention, the antenna assembly contain a short-range wireless antenna selected from the group of a Wi-Fi™ antenna, a Bluetooth™ antenna, a Zigbee™ antenna, and a combination thereof. Such wireless technologies, equipment, standards and protocols useful herein are well-known in the wireless communications art.

In an embodiment herein, the short-range antenna may be combined with the first antenna and/or the second antenna. In an embodiment herein, the first antenna, the second antenna, the long-range antenna, and/or the short-range antenna is a multiple-input and multiple-output (MIMO) antenna.

In an embodiment herein, the first antenna is located within about 30 cm of the second antenna; or within about 20 cm of the second antenna; or within about 15 cm of the second antenna. In an embodiment herein, the first antenna is located from about 5 cm to about 30 cm away from the second antenna; or from about 6 cm to about 20 cm from the second antenna; or from about 7 cm to about 15 cm from the second antenna. In an embodiment herein, the first antenna is located within about 30 cm of the third antenna; or within about 20 cm of the third antenna; or within about 15 cm of the third antenna. In an embodiment herein, the first antenna is located from about 5 cm to about 30 cm away from the third antenna; or from about 6 cm to about 20 cm from the third antenna; or from about 7 cm to about 15 cm from the third antenna. Without intending to be limited by theory, it is believed that the distance between the antennas can be balanced by concerns or optimized to account for, for example, interference, size, aerodynamics in the case of a vehicle antenna, as well as effective use of space and materials.

In an embodiment herein, the first antenna, the second antenna and/or the third antenna are substantially; or completely, enclosed by the base and the housing. Without intending to be limited by theory, it is believed that this reduces the chances of water damage, as well as other environmental complications.

In an embodiment herein, the antenna assembly further contains a third antenna of the same or similar type of antenna as the first antenna and the second antenna; or, where the first antenna, the second antenna, and the third antenna are identical. In an embodiment herein, the third antenna is affixed to the antenna assembly; or the base, and the third antenna is aligned along a third axis. The third axis may be offset at an angle from the first axis, and the third axis may also be offset at an angle from the second axis. Without intending to be limited by theory, it is believed that this allows the third antenna to provide improved reception and/or transmission along a third axis which may be useful in, for example an airplane, a drone, in mountainous regions, etc.

In an embodiment of the present invention, the antenna assembly is included in, for example, a vehicle or any type of moving or mobile item; or a mobile phone, a smart watch, a tablet computer, a computer, a vehicle, a drone, a wireless communication platform such as a balloon or a dirigible, a satellite, and a combination thereof; or a smartphone, a motorcycle, a snowmobile, a personal watercraft, a car, a truck, a camper, a mobile home, a boat, an airplane, a recreational vehicle, and a combination thereof; or a recreational vehicle.

In an embodiment herein, the antenna assembly is designed to be operated on a 12V DC power source, such as an automobile battery. In an embodiment herein, the antenna assembly is operatively-attached to a router, a communications hub, and a combination thereof; or a router inside of the vehicle.

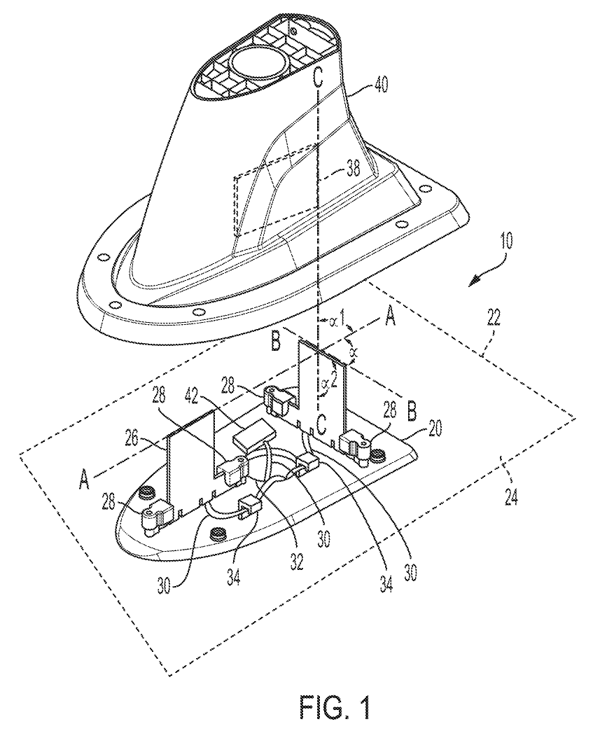

Turning to FIG. 1 which shows an exploded view of an embodiment of an antenna assembly, 10, of the present invention, a base, 20, which may be affixed, permanently or removably, directly or indirectly, to the surface, 22, of for example a mobile device, 24, such as a vehicle, or a recreational vehicle. In other embodiments, the base is a structure of a mobile device to which the antenna assembly is attached. A first antenna, 26, is affixed to the base, 20, via a pair of holders, 28. A wire, 30, which in FIG. 1 is a RF cable, leads from the first antenna, 26, to a hole, 32, which connects to the interior of the mobile device, 24, such as to a router or other communications hub on the inside of a vehicle. A clip, 32, holds the wire, 30, in place.

A second antenna, 36 (like the first antenna, 26), is affixed to the base, 20, via a pair of holders, 28. A wire, 30, which in FIG. 1 is a RF cable, leads from the second antenna, 36, to a hole, 32, which connects to the interior of the mobile device, 24. A clip, 32, holds the wire, 30, in place. Similarly, a third antenna, 38, is affixed to housing, 40, via similar holders (not shown), and is similarly connected to a wire (not shown). The housing, 40, removably-attaches to the base, 20, via a set of screws (not shown). When the housing, 40, is affixed to the base, 20, they substantially enclose the first antenna, 26, the second antenna 36, and the third antenna, 38, rendering the antenna assembly substantially sealing the vulnerable electronic components from the outside environment.

In FIG. 1, the first antenna, 26, the second antenna, 36, and the third antenna, 38, are all identical radio frequency printed circuit board antennas. In FIG. 1, the first antenna, 26, is aligned on the base along a first axis, A-A. The second antenna, 36, is aligned on base along a second axis, B-B. The third antenna, 38, is affixed to the housing, 40, of the antenna assembly, 10, and is aligned along a third axis, C-C. The second axis, B-B, is offset from the first axis, A-A, at an angle, a, which in FIG. 1 is a 90° (right) angle. The third axis, C-C, is offset from the first axis, A-A, at an angle, α¹, which is also a 90° angle. Finally, the third axis, C-C, is offset from the second axis, B-B, at an angle, α², which is also a 90° angle. In embodiments, the first, second and third axes are orthogonal to one another.

A short-range antenna, 42, is further affixed to the base, 20, and connected to a wire, 30, which also leads into the hole, 32. In FIG. 1, the short-range antenna, 42, is a combined Wi-Fi™ and Bluetooth™ antenna which acts as a Wi-Fi™ and Bluetooth™ booster for those within a short distance of the antenna assembly when it is, for example mounted on a recreational vehicle.

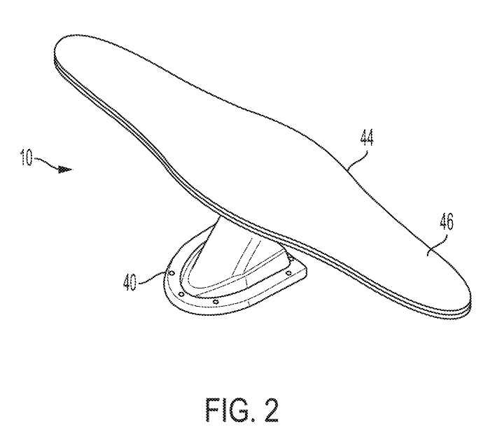

FIG. 2 is a top perspective view of an embodiment of an antenna assembly, 10, of the present invention showing the housing, 40, affixed to a long-range antenna housing, 44 which contains a long-range antenna, 46, inside. The housing, 40, covers a base (see FIG. 1 at 20), and attaches to a vehicle as described in FIG. 1 and herein. In FIG. 2, both the housing, 40, and the long-range antenna housing, 44, are designed to be aerodynamic so as to reduce drag and wind resistance when affixed to a vehicle, an airplane, a drone, etc. In embodiments such as that shown in FIG. 2, the long range antenna 46 is a generally horizontally oriented and generally planar structure, such as a broadcast TV antenna. In embodiments, the long-range antenna 46 is located on a side such as the top of the first, second and third antennas 26, 36, 38. Long-range antennas 46 configured and located in this manner can reduce or minimize any impact on the operational characteristics of the first, second and/or third antennas 26, 36, 38 (e.g., reduce interference with the first, second and third antennas) while providing the additional functionality of the long-range antenna. In embodiments, the long-range antenna 46 can be located from about 5 cm to about 30 cm of the first, second and third antennas 26, 36, 38; or from about 6 cm to about 20 cm from the first, second and/or third antennas; or from about 7 cm to about 15 cm from the first, second and/or third antennas

It should be understood that the above only illustrates and describes examples whereby the present invention may be carried out, and that modifications and/or alterations may be made thereto without departing from the spirit of the invention. It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination. All references specifically cited herein are hereby incorporated by reference in their entireties. However, the citation or incorporation of such a reference is not necessarily an admission as to its appropriateness, citability, and/or availability as prior art to/against the present invention.

What is claimed is:

1. An antenna assembly for a mobile device comprising:
a base;
a first antenna affixed to the base, wherein the first antenna is aligned on the base along a first axis;
a second antenna affixed to the base, wherein the second antenna is aligned on the base along a second axis, wherein the second axis is offset at a non-zero angle from the first axis, and wherein the second antenna is one or both of (1) the same type of antenna as the first antenna, or (2) identical to the first antenna; and
a housing affixed to the base at least partially enclosing the first antenna and the second antenna.

2. The antenna assembly of claim 1, wherein the second axis is offset at an angle from about 85° to about 90° from the first axis.

3. The antenna assembly of claim 1, wherein the first and second antennas are directional antennas, and are selected from the group consisting of a microwave strip antenna, a radio frequency printed circuit board antenna, and a planar array antenna.

4. The antenna assembly of claim 1, wherein the first antenna and the second antenna each have a maximum directive gain of from about 2 dBi to about 10 dBi.

5. The antenna assembly of claim 1, wherein each of the first antenna and the second antenna comprises a cellular antenna selected from the group consisting or a 3G antenna, a 4G antenna, a 5G antenna, a 6G antenna, a CDMA antenna, and a LongTerm Evolution (LTE) antenna.

6. The antenna assembly of claim 1, further comprising a long range antenna affixed to the base, wherein the long range antenna is selected from the group consisting of a broadcast television antenna, a satellite antenna, and digital radio antenna.

7. The antenna assembly of claim 1, further comprising a short range wireless antenna selected form the group consisting of a Wi-Fi™ antenna, a Bluetooth™ antenna, and a Zigbee™ antenna.

8. The antenna assembly of claim 1, wherein the first antenna and the second antenna are selected from the group consisting or a monopole antenna, an inverted F antenna, an inverted L antenna, a planar F antenna, a patch antenna, and a multiple patch antenna.

9. The antenna assembly of claim 1, wherein the first antenna is located within about 15 cm of the second antenna.

10. The antenna assembly of claim 1, and further comprising a third antenna affixed to the antenna assembly and aligned along a third axis, wherein the third antenna is one or both of (1) the same type of antenna as the first antenna and the second antenna, or (2) identical to the first antenna and the second antenna, wherein the third axis is offset at a non-zero angle from the first axis, and wherein the third axis is offset at a non-zero angle from the second axis.

11. The antenna assembly of claim 10, wherein the third axis is offset at an angle from about 85° to about 90° from the first axis, and the third axis is offset at an angle from about 85° to about 90° from the second axis.

12. The antenna assembly of claim 1, and further including a vehicle, wherein the antenna assembly is affixed to the vehicle.

13. The antenna assembly of claim 1, and further including a mobile phone, wherein the antenna assembly is affixed to the mobile phone.

14. An antenna assembly for a mobile device comprising:
a base;
a first antenna affixed to the base, wherein the first antenna is aligned on the base along a first axis;
a second antenna affixed to the base, wherein the second antenna is aligned on the base along a second axis, wherein the second axis is offset at an angle from about 85° to about 90° from the first axis, and wherein the second antenna is one or both of (1) the same type of antenna as the first antenna, or (2) identical to the first antenna;
a third antenna affixed to the base, wherein the third antenna is aligned on the base along a third axis, wherein the third axis is offset at an angle from about 85° to about 90° from the first axis and offset at an angle from about 85° to about 90° from the second axis, and wherein the third antenna is one or both of (1) the same type of antenna as the first and second antennas, or (2) identical to the first and second antennas;
a housing affixed to the base at least partially enclosing the first antenna, the second antenna and the third antenna.

15. The antenna assembly of claim 14 wherein the first antenna, the second antenna, and the third antenna, are identical to one another.

16. The antenna assembly of claim 15 wherein the first, second and third antennas are directional antennas, and are selected from the group consisting of a microwave strip antenna, a radio frequency printed circuit board antenna, and a planar array antenna.

17. The antenna assembly of claim 16 wherein the first, second and third antennas each have a maximum directive gain of from about 2 dBi to about 10 dBi.

18. The antenna assembly of claim 17 wherein the first, second and third antennas are located within about 15 cm of one another.

19. The antenna assembly of claim 18, further comprising a long range antenna affixed to the base, wherein the long range antenna is selected from the group consisting of a broadcast television antenna, a satellite antenna, and digital radio antenna.

20. The antenna assembly of claim 19, further comprising a short range wireless antenna affixed to the base, wherein the short range wireless antenna is selected form the group consisting of a Wi-Fi™ antenna, a Bluetooth™ antenna, and a Zigbee™ antenna.
